(19) United States
(12) Patent Application Publication
(10) Pub. No.: US 2023/0121250 A1
(43) Pub. Date: Apr. 20, 2023

(54) SYSTEM AND METHOD OF USING SUSTAINABILITY TO MAKE AUTOMATED INFRASTRUCTURE COMPUTING DEPLOYMENTS

(71) Applicant: EMC IP Holding Company LLC, Hopkinton, MA (US)

(72) Inventors: Nicole Reineke, Northborough, MA (US); Robert A. Lincourt, Franklin, MA (US); Eloy Francisco Macha, Las Cruces, NM (US); David Frattura, Stamford, CT (US)

(21) Appl. No.: 17/450,909

(22) Filed: Oct. 14, 2021

(51) Int. Cl. G06Q 10/06; G06Q 30/00; G06F 9/50

(52) U.S. Cl. CPC G06Q 10/06375; G06F 9/5094; G06Q 10/06315; G06Q 30/018; G06F 2209/504

(57) ABSTRACT

One example method includes at an infrastructure computing system, receiving a request for infrastructure resources from a user of the infrastructure computing system. Sustainability values for at least one entity are accessed. Based on the accessed sustainability values for the at least one entity, one or more sets of resources are identified that can satisfy the request for infrastructure resources. At least one set of resources from the one or more sets of resources are deployed in the infrastructure computing system to satisfy the request for infrastructure resources.

### FIELD OF THE INVENTION

Embodiments of the present invention generally relate to providing resources from an infrastructure computing system to infrastructure computing system users. More particularly, at least some embodiments of the invention relate to systems, hardware, software, computer-readable media, and methods for providing infrastructure computing system resources to a user to meet sustainability requirements for one or more entities associated with the infrastructure computing system.

### BACKGROUND

Computing systems require structural and energy resources to implement. Given that resources are inherently scarce, it is desirable to implement computing systems in so called ‘sustainable’ ways to ensure that resources are used efficiently. Indeed, various corporate, academic, and government bodies have studied resource sustainability and have published various guidelines and requirements for sustainability. Given the diversity of the various organizations studying and mandating sustainability, there are often differences of opinion and/or different requirements mandated by organizations with respect to deploying computing systems and using structural and energy resources. For organizations in the business of providing computing systems, this creates significant difficulty as those organizations must make different computing system deployment decisions depending on multiple factors including locales where the computing systems will be deployed, along with relevant government mandates related to those locales, and customer requirements directed to sustainability.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an infrastructure computing system implementing a sustainability-focused orchestration system;

FIG. 2 discloses aspects of an inheritance structure for entities;

FIG. 3 discloses aspects of a data and operation flow for implementing a sustainability-focused orchestration system; and

FIG. 4 discloses aspects of a computing system.

### DETAILED DESCRIPTION OF SOME EXAMPLE EMBODIMENTS

Embodiments of the present invention generally relate to providing resources from an infrastructure computing system to infrastructure computing system users. More particularly, at least some embodiments of the invention relate to systems, hardware, software, computer-readable media, and methods for providing infrastructure computing system resources to a user to meet sustainability requirements for one or more entities associated with the infrastructure computing system.

Embodiments illustrated herein are directed to receiving a request for infrastructure resources from a user of an infrastructure computing system. Hierarchical sustainability values are accessed for entities. For example, the infrastructure computing system itself may have sustainability values that are required. An organization that is a tenant of the infrastructure computing system may have sustainability values. Due to the hierarchical structure, the organization will inherit the infrastructure computing system’s sustainability values along with its own independent sustainability values. An individual within an organization may have sustainability values. Again, due to the hierarchical structure, the individual (e.g., the user) will inherit the organization sustainability values and the infrastructure computing system sustainability values. The following illustrates a partial list of sustainability factors which may have sustainability values assigned to them:

| | |
|---|---|
| Carbon impacts goal examples | |
| | Operational energy use goals |
| | Optimize placement based on preferred energy source |
| | Lower overall power consumption optimizing utilization of existing equipment or services (ex: through virtualization or consolidation) |
| | Lower overall power consumption through up-to-date or frequent product refresh |
| | Potential increase in power consumption if organization needs to provision additional resources to meet SLAs |
| Carbon footprint (CFP) goal examples | |
| | Lifetime CFP (predicted based on typical lifecycle of specified equipment by organization) |
| | Manufacturing footprint |
| Operational footprint goal examples (energy sourcing) | |
| | Could be positive, neutral, or negative based on who is making the energy sourcing decisions |
| Physical environment goal examples | |
| | Heat generation (micro heat footprint) |
| | Water impact (cooling, geothermal impact) |
| Material use goal examples (not related to carbon footprint) | |
| | Maximize Recycled Materials (Utilization of equipment with recycled materials) |
| | Maximize Renewal materials (things like bioplastics) |
| | Minimize Material and Supply chain environmental impact (precious materials or other materials) |
| End of life impact goal examples | |
| | Reuse (systems and components) |
| | Reuse of materials (commodities) |
| | ThreadUp (systems and components pass-along economy) |
| Lifetime utilization / eWaste calculation goal examples (% used against the global impact.) Sustainability value / external recognition goal examples | |
| | Geographic EVendor / Manufacturers supply chain “green efficiency ratings” (based on secondary source ranking) |
| | Eco ratings (secondary source ranking for hosting physical location environmental policies) |

While certain sustainability factors have been enumerated here, it should be appreciated that this enumeration is by no means exhaustive. Indeed, as sustainability issues continue to be studied, new factors may be added to relevant enumerations, obsolete factors may be removed from relevant enumerations, and certain factors may be updated within relevant enumerations. Thus, the particular enumeration above represents one example enumeration, and should not be interpreted to be limiting of embodiments of the invention.

Based on the accessed sustainability values, embodiments identify one or more sets of resources that can satisfy the request for infrastructure resources. For example, this can be accomplished by determining resource access rights of the user; based on the resource access rights of the user, determining available resources; creating a list of resources based on the determined available resources; performing a tradeoff analysis of resources in the list of resources to create an ordered list; sending the ordered list to the user; receiving user input selecting resources; and adding any secondary requirements. Alternatively automated resource identification can be performed without requesting further input from the user. Further still, in some embodiments, resources for deployment can be identified based on historical resource deployment operations in view of the same or similar sustainability requirements and/or same or similar users such that resources can be identified more efficiently.

At least one set of resources are deployed from the one or more sets of resources in the infrastructure computing system to satisfy the request for infrastructure resources.

Some embodiments may further include functionality for storing information regarding the identified one or more sets of resources that can satisfy the request for infrastructure resources correlated with the sustainability values for at the least one entity in a historian for later use. This can be used to prevent the need for expensive computations in the future. Alternatively, or additionally, this can be used for telemetry computations to determine the effectiveness of deployments with respect to desired sustainability values.

As noted above, identifying one or more sets of resources that can satisfy the request for infrastructure resources can be performed by accessing historical information for previous similar requests. Thus, if sustainability requirements are the same for the same or similar entities, a query can simply be made to the historian and historical resource recommendations are deployments can be used. Similarity can be determined by performing a distance computation, such as with vectors operations to perform Jaccard, cosine, Euclidian, Manhattan or other distance computations to determine similarity with a predefined threshold.

Some embodiments may gamify sustainability endeavors by providing sustainability metrics to the user indicating the results, from a sustainability perspective, of deploying the at least one set of resources in the infrastructure computing system. For example, a dashboard could be provided that correlates user selections of resources with results. For example, embodiments could include graphs and trends correlated to user selections or automated selections. The user can use historical graphs to try and reduce resource usage in a gamified manner.

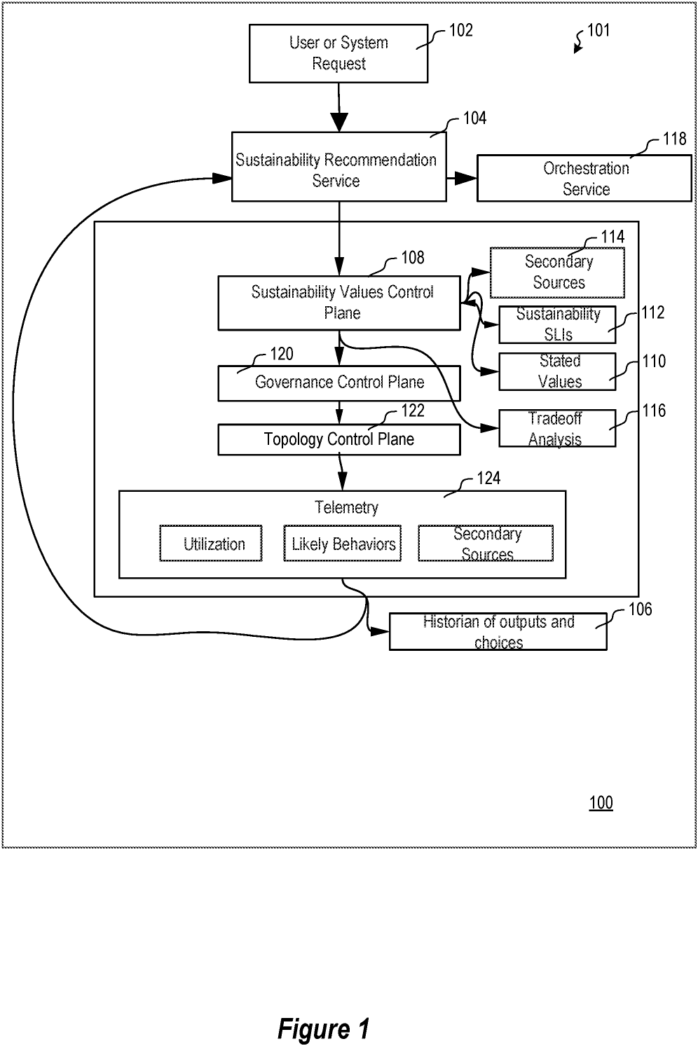

Referring now to FIG. 1, an example system is illustrated. FIG. 1 illustrates an infrastructure computing system 100 having a sustainability-focused orchestration system 101. The sustainability-focused orchestration system 101 may be part of a part of the infrastructure computing system 100 that provides resources to users. Note that the infrastructure computing system 100 may include cloud components, edge components, data center components, other connected infrastructure, and/or combinations thereof. The sustainability-focused orchestration system 101 intercepts user generated or automated requests 102 for resources. Such requests may be instigated, for example, by a catalog request, as a manifest, as a pattern definition, combinations thereof and/or other appropriate means. Such requests may request certain infrastructure resources, such as compute resources, storage and/or memory resources, and/or network resources.

The sustainability-focused orchestration system 101 in the illustrated example includes several components.

The sustainability-focused orchestration system 101 includes a sustainability recommendation service 104. The sustainability recommendation service 104 implements a conduit for requests, such as the request 102, into the sustainability-focused orchestration system 101. The sustainability recommendation service 104 compiles recommendations, annotates rules, values, suggestions and user-selected decisions in a historian 106.

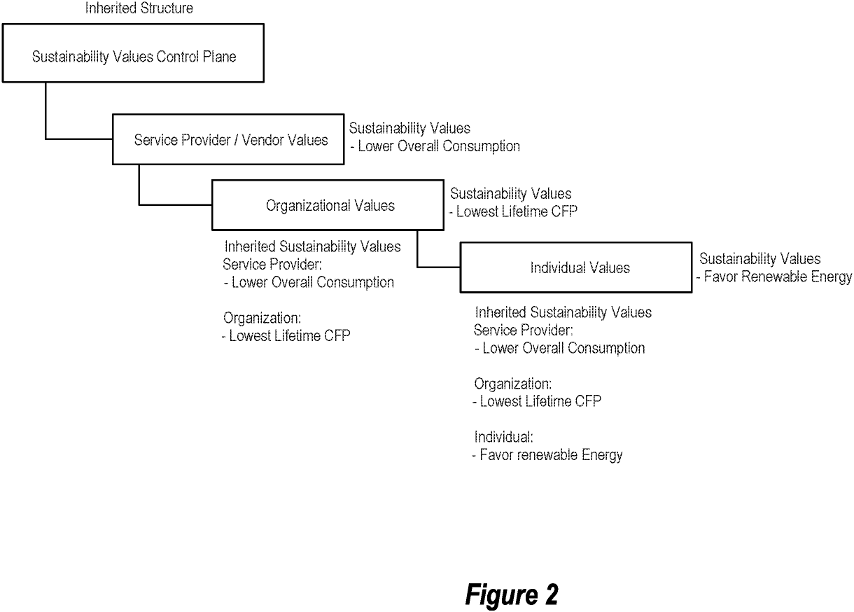

The sustainability-focused orchestration system 101 includes a sustainability values control plane 108. The sustainability values control plane 108 compiles sustainability values 110. As noted, sustainability values can be specified for certain entities. For example, sustainability values may be specified for a service provider (e.g., the entity that owns or operates all or portions of an infrastructure computing system and/or the sustainability-focused orchestration system 101) Sustainability values may be specified for an organization (e.g., a tenant of the infrastructure computing system). Sustainability values may be specified for an individual (e.g., an employee of the tenant organization). Some embodiments implement a hierarchical system that implements complete inherited sustainability values. For example, the top of the hierarchy may be the infrastructure computing system, an intermediate level may be the tenant organization, and a bottom level of the hierarchy may be the individual. Entities inherit sustainability values of higher entities in the hierarchy. Thus, for example, the individual has its own sustainability values as well as sustainability values that it inherits from the tenant organization and the infrastructure computing system. The tenant organization has its own sustainability values as well as sustainability values that it inherits from the infrastructure computing system. The infrastructure computing system has its own sustainability values. Examples of this are illustrated as shown in FIG. 2.

Note that while these levels are illustrated, it should be appreciated that other levels can be implemented. For example, departments in a tenant organization may have their own sustainability values, and may inherit sustainability values from the tenant organization, as well as other higher-level entities. Teams in a department may have their own sustainability values and may inherit sustainability values from the department, as well as other higher-level entities. Etc.

The sustainability values control plane 108 compares resulting recommendations against sustainability SLIs 112 (service level indicators) and/or secondary sources 114, and then performs a tradeoff analysis using tradeoff rules 116 to ensure that minimum standards are met for each request.

Sustainability SLIs 112 are specific, measurable behaviors, goals or results related to any sustainability value or goal. These may include for example, the location at which to obtain the data, maximum latency, processing speed, calculations and other relevant details. This is extendable.

The sustainability values 110 include a list of specific goals that are selected and prioritized by an entity, such as a service provider, vendor, organization, or individual. Each of the sustainability values maps to one or more sustainability SLIs.

The trade-off analysis rules 116 are a set of minimum standards. Such standards may be set by governments, organization, or other entities. For example, such standards may be tied to thresholds for Adverse Outcome (AOI), System Condition (SCI), Resource Flow (RFI) and/or Value Creation (VCI). Adverse Outcome (AOI) indicates level of destruction of value due to impacts upon individuals, communities, business enterprises, or the natural environment. Resource Flow (RFI) indicates levels of pressures associated with the rate of consumption of resources, including materials, energy, water, land, or biota. System Condition (SCI) indicates state of the systems in question, i.e., individuals, communities, business enterprises, or the natural environment. Value Creation (VCI) indicates level of creation of value (both economic and wellbeing) through enrichment of individuals, communities, business enterprises, or the natural environment.

The sustainability-focused orchestration system 101 includes a historian 106. The historian 106 stores a full audit trail of calculations, decisions, inputs and outputs, etc., for use in future calculations, analytics, and/or reporting.

A determination of the inherited sustainability values for the owner of the request is made.

As noted previously, embodiments include an inherited structure for sustainability values. FIG. 2 illustrates an example of how sustainability values are inherited and used for entities by the sustainability values control plane 108.

In the example illustrated, service provider sustainability values are taken into consideration, organizational sustainability values are taken into consideration, and then any individual sustainability values for this user area taken into consideration. For the particular user, the aggregate of the sustainability values from entities higher in the hierarchy (i.e., the organization and the service provider) is used to generate a “Inherited Sustainability Values” manifest.

Rules determination will be set in the sustainability values control plane 108, where inheritance and conflict resolution can be resolved.

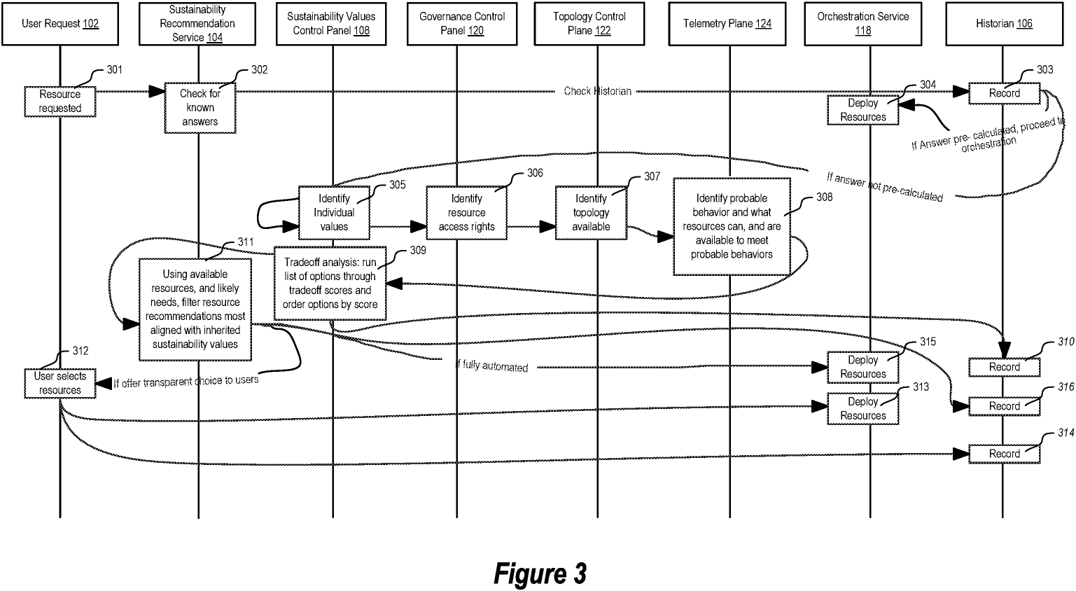

Referring now to FIG. 3, a flow diagram is illustrated showing the various components of the sustainability-focused orchestration system 101, and various actions taken by the various components.

FIG. 3 illustrates a user request 102 to request infrastructure resources, as illustrated at 301, is provided to the sustainability recommendation service 104. The user request 102 may include sustainability values for an entity, such as an individual (including in some embodiments, inherited sustainability values from higher level entities).

In some embodiments, the sustainability recommendation service 104 will initiate a check for known answers, as illustrated at 302. In particular, a check will be made against the historian 106 to identity a record 303 of previous resource deployments that are sufficiently similar to the present request. For example, the check will be made to identify requests with similar sustainability values and/or workload profiles.

In some embodiments, the check will simply be made to determine if an entity has previously requested the same resources. These embodiments presuppose that an entity’s sustainability values have not changed. In some embodiments, this can be confirmed by checking a flag that can be set for an entity when their sustainability values change. Alternatively, embodiments may subscribe to a publication/subscription service that published when entities change sustainability values. If an entity has changed their sustainability values, then the pre-check to the historian 106 can be avoided.

The check may need to return an identical record in some embodiments. In other embodiments, a sufficiently similar record may need to be identified according to some predetermined threshold level. For example, the parameters of the request 102 may be vectorized and distances may be computed between the present request and records stored at the historian. Such computations may use Jaccard, cosine, Euclidian, Manhattan, or other distance computations. If the request and a previously recorded record are sufficiently ‘close’, then an answer is pre- calculated (and stored at the historian 106) and embodiments can proceed to orchestration by the orchestration service 118 which will deploy resources satisfying the request 102, as illustrated at 304. If this pre-calculated answer can be used, then the processing illustrated at 305-316 can be avoided to reduce the use of computing and other resources at the infrastructure computing system 100.

However, if an answer is not precalculated (either as a result of no similar record appearing in the historian 106 or if the historian is not checked for similar records), then processing continues at the sustainability values control plane 108, where individual (or other entity) sustainability values are identified as illustrated at 305. As noted, these may be specified by the individual (or other entity), and in some embodiments may include additional sustainability values that are inherited from higher entities in a hierarchy.

Processing then proceeds at the governance control plane 120 where resource access rights are identified as illustrated at 306. In particular, access rights may be limited based on tenant rights, organization rights, individual rights or the like. Thus, resources that are available to the individual can be identified in this operation.

Processing then proceeds to the topology control plane 122 where the topology control plane 122 Identifies one or more available topologies. A topology includes the resources which are available to the tenant, including but not limited to servers, storage, and processing capabilities. The topology shows how the resource are interconnected. This allows embodiments to utilize the SLIs that are import at this point in the hierarchy. So, for example the data maybe located in a zone that has a max power level at which it can run. Consider a case where it is known that the computation on the data will exceed the threshold. However, relocating the data once (to pay the price in terms of resources and cost) the processing threshold is avoided.

Processing then proceeds to the telemetry plane 124. The telemetry plane 124 is a diagnostic system that is able to measure and evaluate resource usage and capabilities. This may be based on historical trends, resource loads, scheduling, and/or other factors. As illustrated at 308, the telemetry plane identifies probable behaviors and what resources can and are available to meet probable behaviors. Metrics are captured for each SLI.

Processing then proceeds to the sustainability values control plane 108, where a tradeoff analysis is performed as illustrated at 309. For example, a customer may have priorities in both power consumption and lifetime carbon footprint, a determination may be made that the overall carbon footprint exceeds the minor improvement in power consumption. Alternatively, a customer may have priorities in both power consumption and data locality. Thus, a determination may need to be made as to the need to move data in order to process it. Depending on a customer’s SLIs, embodiments may choose a higher carbon impact over a slightly slower ability to process data; or even over the data movement itself. In this analysis, a list of options is accessed and tradeoff scores are computed. Options are ranked by tradeoff score, in some embodiments from highest to lowest.

As illustrated at 310, processing proceeds from the sustainability values control plane 108 to the historian 106 where the ranked tradeoff scores are recorded in conjunction with the individual entity and/or the sustainability values. Note that in some embodiments, the individual may be a proxy for the sustainability values as the sustainability values are constant for the individual, such that correlations can be made to ranked lists and the individual, without necessarily correlating directly to sustainability values. Rather, a separate record may correlate sustainability values to the individual.

Further processing proceeds from the sustainability values control plane 108 to the sustainability recommendation service 104. As illustrated at 311, using available resources, and likely needs, the sustainability recommendation service 104 can filter resource recommendations from the ordered list to identify elements in the list most aligned with inherited sustainability values. Such factors that may be considered here include: most recycled components, cleanest power resources, cheapest cost resources, resources logically or physically closest to clients, latency, or other similar considerations.

Processing can proceed from the sustainability recommendation service 104 in either a manually inclusive fashion, or an automated fashion. If embodiments offer a transparent manually inclusive choice to users, then processing proceeds to the user request 102 (e.g., to a user interface) where the user is presented with a filtered and ordered list. The user can select an element from the list as illustrated at 312 causing processing to proceed to the orchestration service 118, where the resources are deployed in the infrastructure computing system 100 according to the user selection as illustrated at 313. Also, in conjunction with the manually inclusive deployment, a record is written to the historian 106 as illustrated at 314 to indicate the automatic selection and deployment of resources.

In contrast, if fully automated resource deployment is implemented, processing proceeds from the sustainability recommendation service 104 directly to the orchestration service 118 where resources are deployed as illustrated at 315. In some embodiments, the top choice from the ordered list will be used to determine resources to be deployed. Also, in conjunction with the automatic deployment, a record is written to the historian 106 as illustrated at 316 to indicate the automatic selection and deployment of resources.

Thus, embodiments may implement a system and method that enables the use of individualized, inherited sustainability values in orchestration recommendations that takes into account measurable service level indicators.

Due to the impact and implications of sustainability on the orchestration engine(s) these service level indictors (SLI) are defined before the core orchestration decisions are made. Potential sustainability the values are numerous and sometimes conflicting, especially when vendor, organizational and individual values are combined to create a single policy that is handed to the core orchestrator to provision the resources required. These SLIs now need to be combined with other SLOs and SLAs to achieve the desired results.

Further, embodiments implement use of inherited sustainability values in in orchestration recommendations for use by infrastructure systems for decision making.

The SLI or sustainable policy or polices are combined, potentially utilizing combinatoric algorithms to identify the correct patterns and deciding which SLI or sustainability value is to be done first or is dominate over other SLIs or sustainability values. This information (policy or SLI) is then sent down to the system or infrastructure orchestrator for predefining the set of resources that best fit these requirements. From the resource pools that best match, the orchestrator can now operate as normal.

Further, embodiments use a historian to record recommendations, calculations and SLIs within the sustainability-aware system, and create records of decision-making results, whether automated or manual.

As with most decision systems, a record of decisions and data used to make these decisions is stored in a tamper proof system, such as an immutable log or ledger depending on scale. Along with this information, the resource utilization of the decision is persisted to verify the decision is actually saving resources as stated. Alternatively, determinations can be made that the algorithms and amount of data to make these decisions outweighs the potential benefits.

Embodiments make use of historian data for improved decision making in future recommendations.

As the use of the historian gathers data over time, this historical information is utilized to pre-seed or correct decisions over time. This enables the recommendation system to reduce its own footprint over time.

Embodiments identify changes in records or value calculations to identify trends (positive or negative) in SLIs for use in decision making.

The historian allows auditors, service providers and vendors, and individual users or applications to show users status on their goals. This will aid in applications creating more gamification on how to alter user behaviors to get them to align to their goals. At the same time this gamification will also provide more data to the historian to make better decisions on what is actually important to all users of these resources. As users’ behaviors change or are altered these trends can be reported to the inherited parties so overall goals can be updated.

The following now illustrates a specific use case example.

A customer uses an infrastructure system, and as part of infrastructure system they are able to use any locally managed equipment or cloud equipment for placement choice.

A request comes in for a workload deployment.

The sustainability recommendation service 104 receives the request, a check is sent to the historian 106 to determine if there is a known inherited sustainability value result for this request type for this user. If that exists, a check for a recent resource recommendation of a matching type is made. If this exists, the recommended resource use is sent directly to the orchestrator service.

If this is a new request type or user, a trigger is sent to the sustainability values control plane 108. The sustainability values control plane 108 determines the inherited sustainability value for the requesting user. In this case, we will use an example where the vendor has set a sustainability value that pursues low power consumption where possible. The users’ organization has set that they are measured against carbon footprint for the lifetime of the consumption of resources. This means that if the organization buys new hardware, they are responsible for reporting on the full product carbon footprint from manufacturing to decommissioning. The individual (or group) in this case has set a goal of utilizing recycled resources wherever possible.

The goals are compiled into a single Inherited sustainability values list. The weighting of the list may be set based on rules, but for simplicity sake, in this example, the most specific rule wins when there is conflict.

The governance control plane 120 determines access rights. This is matched against the topology and purchase types available to requesting user.

The workload needs are then matched against the known available resources.

From the possible providers of the resources, embodiments create an ordered list using the inherited sustainability values as the rules and the sustainability service level indicators which are stored regarding each asset in the telemetry plane 124.

The ordered list is returned to the sustainability values control plane 108.

The sustainability values control plane 108 takes the list of options and runs the top options through a basic tradeoff analysis to ensure that the recommendations do not have any unintended negative adverse outcomes (per Environmental Protection Agency (EPA) or other selected standards). The ordered list that passes the tradeoff analysis is handed back to the sustainability recommendation service 104. This is returned to the user. The user selected the preferred deployment and the recommendation is sent to the orchestration service 118 (which then applies any secondary requirements).

The rules, values and the results of the recommendation along with the user choice is written to the historian 106.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are described herein forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

### Aspects of An Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

It is noted with respect to the example methods illustrated herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### Further Example Embodiments

Following are some further example embodiments of the invention. These are presented only by way of example and are not intended to limit the scope of the invention in any way.

Embodiment 1. A method, comprising: at an infrastructure computing system, receiving a request for infrastructure resources from a user of the infrastructure computing system; accessing sustainability values for at least one entity; based on the accessed sustainability values for the at least one entity, identifying one or more sets of resources that can satisfy the request for infrastructure resources; and deploying at least one set of resources from the one or more sets of resources in the infrastructure computing system to satisfy the request for infrastructure resources.

Embodiment 2. The method of embodiment 1 further comprising: providing an ordered list of the one or more sets of resources to the tenant; receiving user input selecting from the ordered list the at least one set of resources from the one or more sets of resources; and wherein deploying the at least one set of resources is based on the user input.

Embodiment 3. The method of embodiment 1 and/or 2 wherein deploying the at least one set of resources is performed in an automated fashion at the infrastructure computing system based on an automated ranking of sets in the one or more sets of resources.

Embodiment 4. The method of embodiment 1, 2, and/or 3 further comprising, storing information regarding the identified one or more sets of resources that can satisfy the request for infrastructure resources correlated with the sustainability values for at the least one entity.

Embodiment 5. The method of embodiment 1, 2, 3, and/or 4 wherein identifying one or more sets of resources that can satisfy the request for infrastructure resources is performed by accessing historical information for previous similar requests.

Embodiment 6. The method of embodiment 1, 2, 3, 4 and/or 5 wherein identifying one or more sets of resources that can satisfy the request for infrastructure resources is performed by using a resource determination based on previous resource deployment decisions.

Embodiment 7. The method of embodiment 1, 2, 3, 4, 5, and/or 6 wherein identifying one or more sets of resources that can satisfy the request for infrastructure resources is performed by: determining resource access rights of the user; based on the determined resource access rights of the user, determining available resources; creating a list of resources based on the determined available resources; performing a tradeoff analysis of resources in the list of resources; creating an ordered list based on the tradeoff analysis, and wherein deploying the at least one set of resources is based on the ordered list.

Embodiment 8. The method of embodiment 1, 2, 3, 4, 5, 6, and/or 7 further comprising performing telemetry computations to assess if sustainability values for the at least one entity are met as a result of deploying the at least one set of resources in the infrastructure computing system.

Embodiment 9. The method of embodiment 1, 2, 3, 4, 5, 6, 7, and/or 8 further comprising providing sustainability metrics to the user indicating the results, from a sustainability perspective, of deploying the at least one set of resources in the infrastructure computing system.

Embodiment 10. The method of embodiment 1, 2, 3, 4, 5, 6, 7, 8 and/or 9 wherein the sustainability values for at least one entity comprise inherited hierarchical values from a hierarchy comprising two or more entities selected from a service provider, the tenant, a department within the tenant or a user of the tenant, wherein at least one of the sustainability values is for an entity that inherits the at least one on of the sustainability values from an entity higher in the hierarchy.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1 through 11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

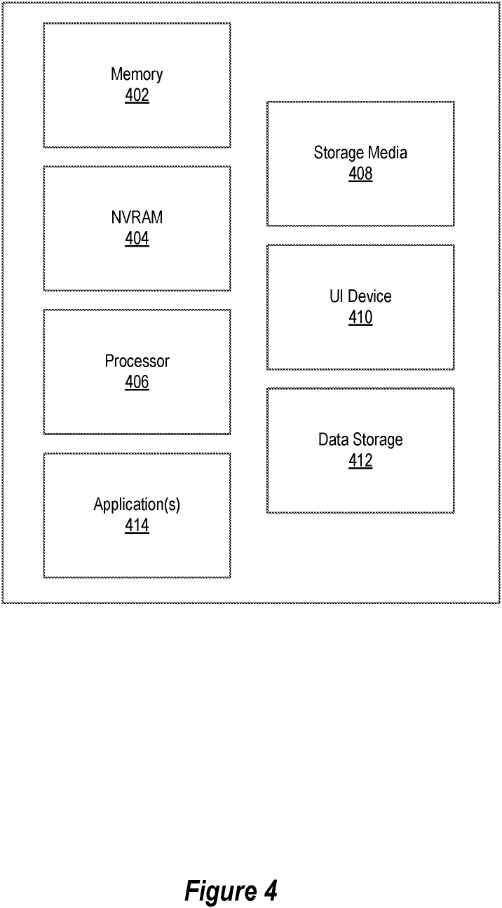

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random-access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
at an infrastructure computing system, receiving a request for infrastructure resources from a user of the infrastructure computing system;
accessing sustainability values for at least one entity;
based on the accessed sustainability values for the at least one entity, identifying one or more sets of resources that can satisfy the request for infrastructure resources; and
deploying at least one set of resources from the one or more sets of resources in the infrastructure computing system to satisfy the request for infrastructure resources.

2. The method of claim 1 further comprising:
providing an ordered list of the one or more sets of resources to the tenant;
receiving user input selecting from the ordered list the at least one set of resources from the one or more sets of resources; and
wherein deploying the at least one set of resources is based on the user input.

3. The method of claim 1 wherein deploying the at least one set of resources is performed in an automated fashion at the infrastructure computing system based on an automated ranking of sets in the one or more sets of resources.

4. The method of claim 1 further comprising, storing information regarding the identified one or more sets of resources that can satisfy the request for infrastructure resources correlated with the sustainability values for at the least one entity.

5. The method of claim 1 wherein identifying one or more sets of resources that can satisfy the request for infrastructure resources is performed by accessing historical information for previous similar requests.

6. The method of claim 1 wherein identifying one or more sets of resources that can satisfy the request for infrastructure resources is performed by using a resource determination based on previous resource deployment decisions.

7. The method of claim 1 wherein identifying one or more sets of resources that can satisfy the request for infrastructure resources is performed by:
determining resource access rights of the user;
based on the determined resource access rights of the user, determining available resources;
creating a list of resources based on the determined available resources;
performing a tradeoff analysis of resources in the list of resources;
creating an ordered list based on the tradeoff analysis, and
wherein deploying the at least one set of resources is based on the ordered list.

8. The method of claim 1 further comprising performing telemetry computations to assess if sustainability values for the at least one entity are met as a result of deploying the at least one set of resources in the infrastructure computing system.

9. The method of claim 1 further comprising providing sustainability metrics to the user indicating the results, from a sustainability perspective, of deploying the at least one set of resources in the infrastructure computing system.

10. The method of claim 1 wherein the sustainability values for at least one entity comprise inherited hierarchical values from a hierarchy comprising two or more entities selected from a service provider, the tenant, a department within the tenant or a user of the tenant, wherein at least one of the sustainability values is for an entity that inherits the at least one on of the sustainability values from an entity higher in the hierarchy.

11. A non-transitory storage medium having stored therein instructions that are executable by one or more hardware processors to perform operations comprising:
at an infrastructure computing system, receiving a request for infrastructure resources from a user of the infrastructure computing system;
accessing sustainability values for at least one entity;
based on the accessed sustainability values for the at least one entity, identifying one or more sets of resources that can satisfy the request for infrastructure resources; and
deploying at least one set of resources from the one or more sets of resources in the infrastructure computing system to satisfy the request for infrastructure resources.

12. The non-transitory storage medium of claim 11 further having stored therein instructions that are executable by one or more hardware processors to perform operations comprising:
providing an ordered list of the one or more sets of resources to the tenant;
receiving user input selecting from the ordered list the at least one set of resources from the one or more sets of resources; and
wherein deploying the at least one set of resources is based on the user input.

13. The non-transitory storage medium of claim 11 wherein deploying the at least one set of resources is performed in an automated fashion at the infrastructure computing system based on an automated ranking of sets in the one or more sets of resources.

14. The non-transitory storage medium of claim 11 further having stored therein instructions that are executable by one or more hardware processors to perform operations comprising storing information regarding the identified one or more sets of resources that can satisfy the request for infrastructure resources correlated with the sustainability values for at the least one entity.

15. The non-transitory storage medium of claim 11 wherein identifying one or more sets of resources that can satisfy the request for infrastructure resources is performed by accessing historical information for previous similar requests.

16. The non-transitory storage medium of claim 11 wherein identifying one or more sets of resources that can satisfy the request for infrastructure resources is performed by using a resource determination based on previous resource deployment decisions.

17. The non-transitory storage medium of claim 11 wherein identifying one or more sets of resources that can satisfy the request for infrastructure resources is performed by:
determining resource access rights of the user;
based on the determined resource access rights of the user, determining available resources;
creating a list of resources based on the determined available resources;
performing a tradeoff analysis of resources in the list of resources;
creating an ordered list based on the tradeoff analysis, and
wherein deploying the at least one set of resources is based on the ordered list.

18. The non-transitory storage medium of claim 11 further having stored therein instructions that are executable by one or more hardware processors to perform operations comprising performing telemetry computations to assess if sustainability values for the at least one entity are met as a result of deploying the at least one set of resources in the infrastructure computing system.

19. The non-transitory storage medium of claim 11 further having stored therein instructions that are executable by one or more hardware processors to perform operations comprising providing sustainability metrics to the user indicating the results, from a sustainability perspective, of deploying the at least one set of resources in the infrastructure computing system.

20. The non-transitory storage medium of claim 11 wherein the sustainability values for at least one entity comprise inherited hierarchical values from a hierarchy comprising two or more entities selected from a service provider, the tenant, a department within the tenant or a user of the tenant, wherein at least one of the sustainability values is for an entity that inherits the at least one on of the sustainability values from an entity higher in the hierarchy.
